(19) United States
(12) Patent Application Publication
(10) Pub. No.: US 2005/0157482 A1
(43) Pub. Date: Jul. 21, 2005

(54) Non-interruption light source

(76) Inventor: Tsai-Cheng Hsu, Tu-Cheng City (TW)

Correspondence Address: SUPREME PATENT SERVICES, POST OFFICE BOX 2339, SARATOGA, CA, 95070, US

(21) Appl. No.: 10/760,029

(22) Filed: Jan. 16, 2004

(51) Int. Cl. F21L 13/00; F21V 19/04

(52) U.S. Cl. 362/20; 362/183; 362/363

(57) ABSTRACT

A non-interruption light source includes a base, a casing, a battery, a light source, a shade and a circuit board. The base is connected to the casing that is connected to the shade. A space enclosed by the casing the shade receives the circuit board, the battery and the light source and the circuit board, the battery and the light source are connected with each other by wires. The circuit board transfers alternative current into direct current that is provided to the light source. The circuit board detects whether or not the primary power supply is cut and switches to the power of battery accordingly.

### FIELD OF THE INVENTION

The present invention relates to a non-interruption light source having a spare power supply that provides power to the light source when the primary power is gone.

### BACKGROUND OF THE INVENTION

A conventional light source such as lamps cannot function normally when the power supply of the house is gone. Some emergency light devices are developed to provide minimum luminous requirement and these devices include their own power supply systems. Nevertheless, people do not purchase these emergency light devices to be their luminous devices in rooms because these devices need extra installing processes and most of them do not have esthetic contour and shape.

Therefore, it is desired to have a non-interruption light source that employs a detection circuit to send a signal to activate a spare power supply when the primary power supply is gone such that the light source functions without interruption.

### SUMMARY OF THE INVENTION

In accordance with an aspect of the present invention, there is provided a non-interruption light source that comprises a base connected to a casing that is connected to shade. A battery, which is preferably a rechargeable battery, a light source and a circuit board are received in a space between the casing and the shade. The circuit board, the battery and the light source are electrically connected with each other by wires.

The circuit board comprises a power circuit, a charging circuit, a detection circuit and a switching circuit. An alternative current source provides alternative current to the power circuit and the alternative current is switched into direct current so as to be supplied to the charging circuit, the switching circuit and the detection circuit. The alternative current source provides alternative current to the detection circuit that detects whether or not the alternative current is cut. The charging circuit charges the rechargeable battery that provides electric current to the switching circuit which is powered normally by the power circuit. The switching circuit supplies direct current provided by the power circuit to the light source when no signal is sent to the switching circuit from the detection circuit. The switching circuit supplies direct current provided by the rechargeable battery to the light source when a signal is sent to the switching circuit 32 from the detection circuit.

The present invention will become more obvious from the following description when taken in connection with the accompanying drawings, which show, for purposes of illustration only, a preferred embodiment in accordance with the present invention.

### BRIEF DESCRIPTION OF THE DRAWINGS

FIG. 1 is an exploded view of a non-interruption light source constructed in accordance with the present invention;

FIG. 2a is a block diagram of a circuit used in the example with a rechargeable battery;

FIG. 2b is a block diagram of a circuit used in the example without a rechargeable battery;

FIG. 3a shows a circuit with a rechargeable battery;

FIG. 3b shows a circuit without a rechargeable battery;

FIG. 4 shows that the shade is a spherical shape;

FIG. 5 shows that the shade is a spiral tube;

FIG. 6 shows that the shade is three U-shaped tubes;

FIG. 7 shows how the non-interruption light source is connected to the switch and the power supply.

### DETAILED DESCRIPTION OF THE PREFERRED EMBODIMENT

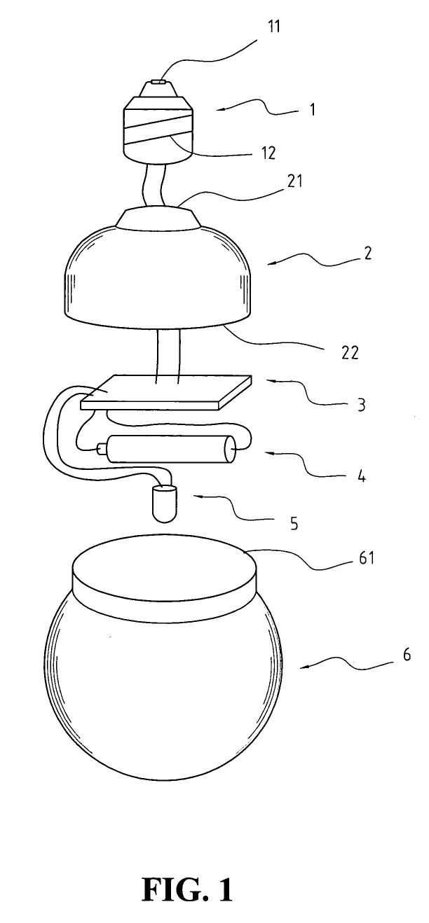

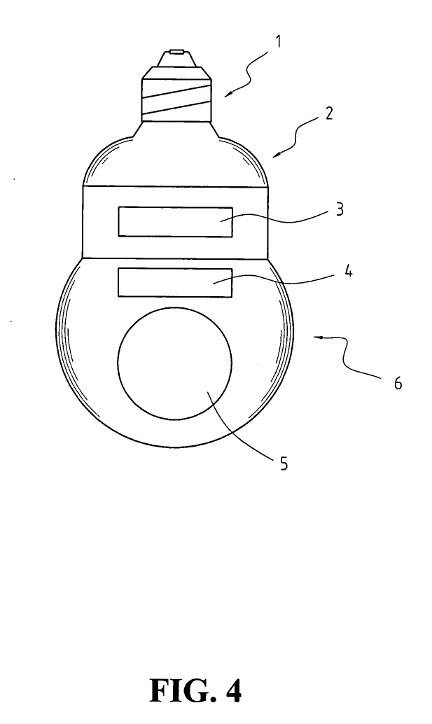

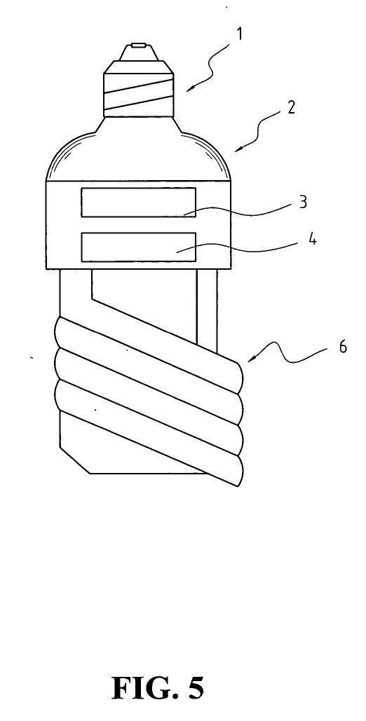

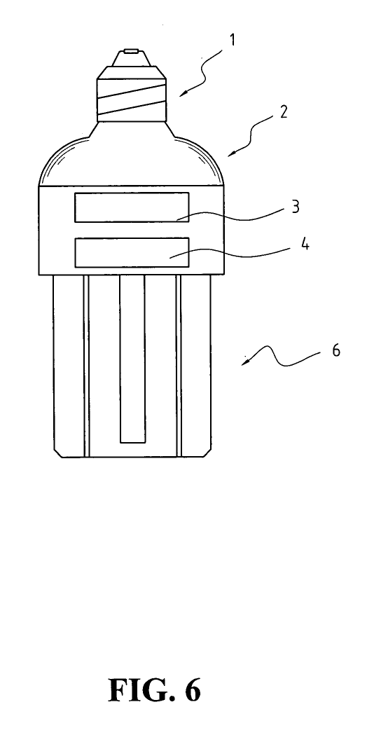

Referring to the drawings and in particular FIG. 1, a non-interruption light source comprises a base 1 which has threaded outer periphery 12 so as to be connected to a conventional socket, and a tip contact 11 which is separated from the ring contact by a separation material. A casing 2 has an end 21 connected to the base 1 by either ways of force-fitted, welding or gluing. A shade 6 has an opening 61 and the other end of the casing 2 is engaged with the opening 61. The casing 2 can be connected to the shade 6 by way of threaded connection, doweled joint or rotating a doweled joint. A battery 4, which is a rechargeable battery 41 in this embodiment, a light source 5 and a circuit board 3 are received in a space between the casing 2 and the shade 6. The base 1 is connected to the circuit board 3 by two wires and the circuit board 3 is electrically connected to the battery 4 and the light source 5 respectively by two sets of wires. The light source 5 can be a single light emitting diode or composed of a plurality of light emitting diodes, as long as the luminance and color meets the requirement. The shade 6 can be a spherical shade as shown in FIG. 4, a spiral tube as shown in FIG. 5 or three U-shaped tubes as shown in FIG. 6.

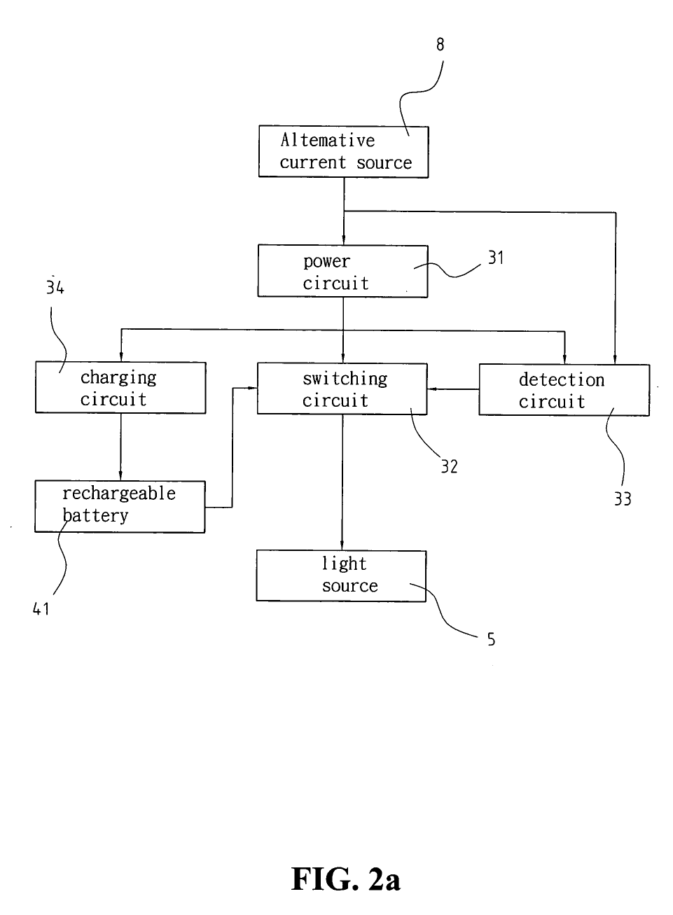

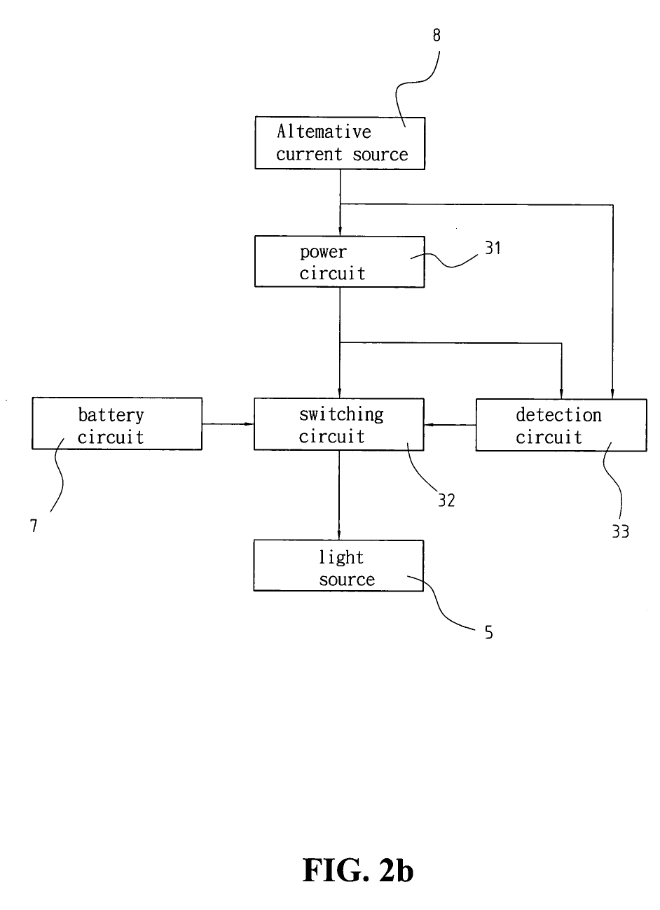

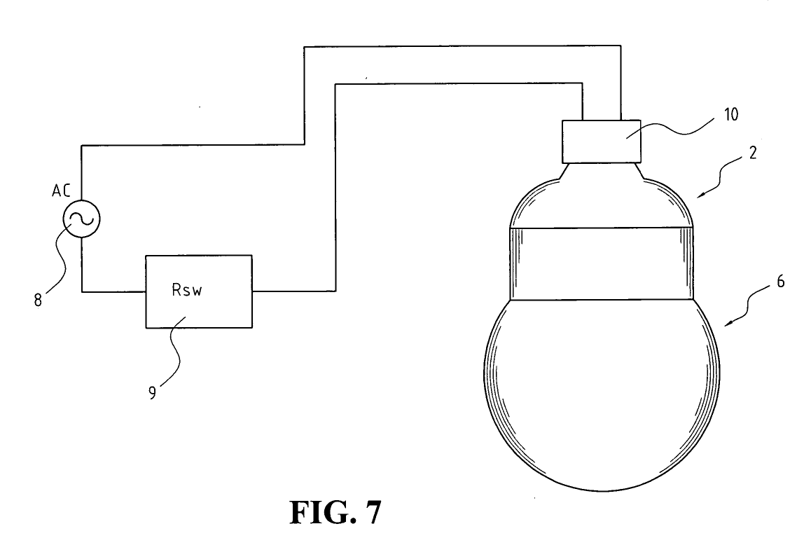

Referring to FIGS. 2a, 3a and 7, the circuit board 3 comprises a power circuit 31, a charging circuit 34, a detection circuit 33 and a switching circuit 32. An alternative current source 8 provides alternative current to the power circuit 31 and the alternative current is switched into direct current that is supplied to the charging circuit 34, the switching circuit 32 and the detection circuit 33. A switch 9 is connected to the power source 8 and is operated by the user to connect the close or open the circuit. The alternative current source 8 provides alternative current to the detection circuit 33 which detects whether or not the alternative current is cut by detecting no current coming form the alternative power source 8. When the detection circuit 33 detects that the alternative current is cut, this means no current exists when the switch 9 is positioned at “ON” position. The charging circuit 34 charges the rechargeable battery 41 which provides electric current to the switching circuit 32 which is powered normally by the power circuit 31 via the alternative power source 8. The switching circuit 32 supplies direct current provided by the power circuit 31 to the light source 5 when no signal is sent to the switching circuit 32 from the detection circuit 33. The switching circuit 32 supplies direct current provided by the rechargeable battery 41 to the light source 5 when a signal is sent to the switching circuit 32 from the detection circuit 33.

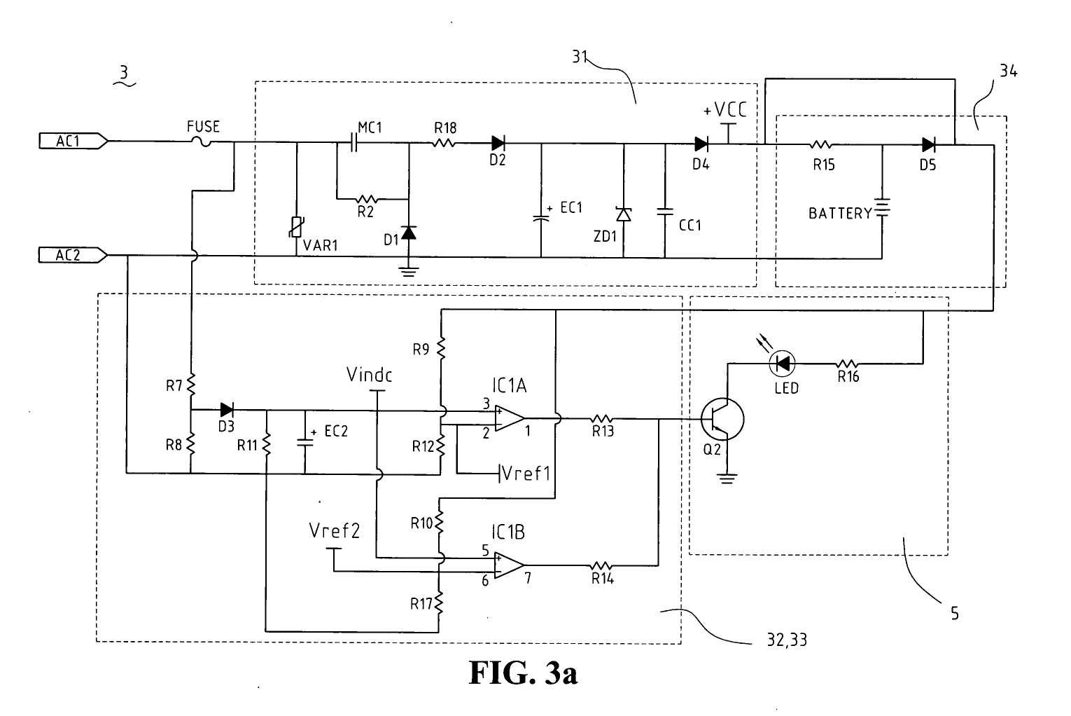

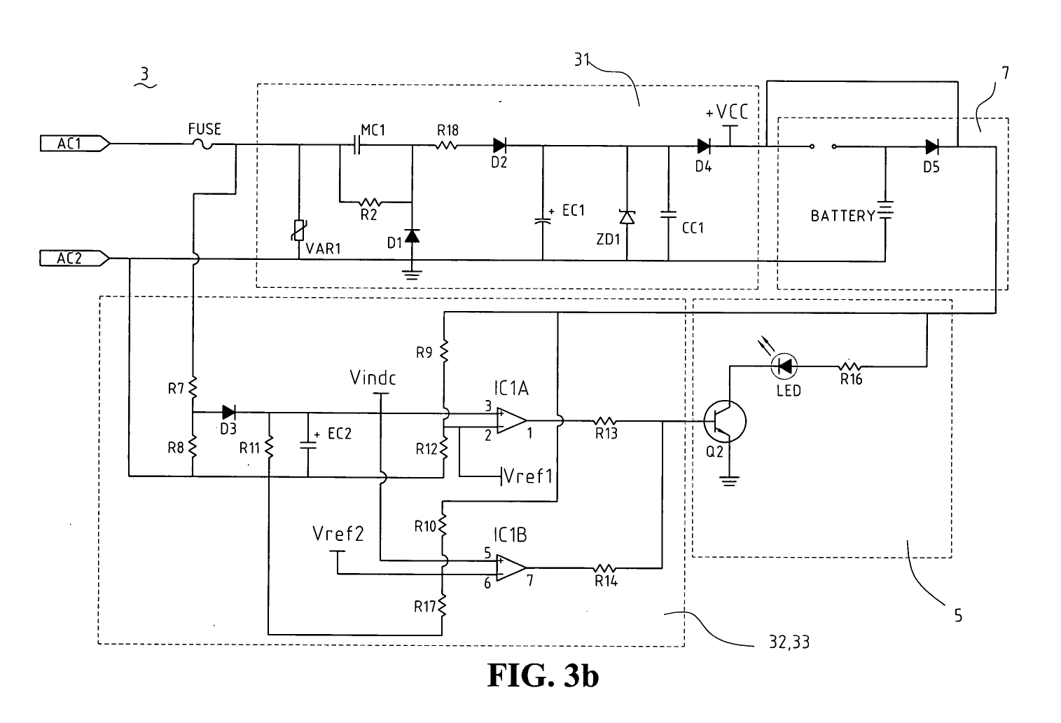

Referring to FIGS. 2b and 3b, another embodiment of the light source has the same components as the previous embodiment disclosed in FIG. 1, except for that the battery 4 in this embodiment is not a rechargeable battery 41. The battery 4 used in this embodiment is a carbon-zinc or alkaline battery. The other difference relative to the previous embodiment is that the circuit board 3 comprises a power circuit 31, a battery circuit 7, a detection circuit 33 and a switching circuit 32. An alternative current source 8 provides alternative current to the power circuit 31 and the alternative current is switched into direct current that is supplied to the switching circuit 32 and the detection circuit 33. The alternative current source 8 provides alternative current to the detection circuit 33 that detects whether or not the alternative current is cut. The battery circuit 7 provides a power supply to the switching circuit 32 that is powered normally by the power circuit 31. The switching circuit 32 supplies direct current provided by the power circuit 31 to the light source 5 when no signal is sent to the switching circuit 32 from the detection circuit 33. The switching circuit 32 supplies direct current provided by the battery circuit 7 to the light source 5 when a signal is sent to the switching circuit 32 from the detection circuit 33.

While we have shown and described the embodiment in accordance with the present invention, it should be clear to those skilled in the art that further embodiments may be made without departing from the scope of the present invention.

1. A non-interruption light source comprising:
a base;
a casing having an end connected to the base;
a battery which is a rechargeable battery;
a light source;
a shade having an opening and the other end of the casing being engaged with the opening;
a circuit board comprising a power circuit, a charging circuit, a detection circuit and a switching circuit, an alternative current source providing alternative current to the power circuit and the alternative current being switched into direct current which is supplied to the charging circuit, the switching circuit and the detection circuit, the alternative current source providing alternative current to the detection circuit which detects whether or not the alternative current is cut, the charging circuit charging the rechargeable battery which provides electric current to the switching circuit which is powered normally by the power circuit, the switching circuit supplying direct current provided by the power circuit to the light source when no signal is sent to the switching circuit from the detection circuit, the switching circuit supplying direct current provided by the rechargeable battery to the light source when a signal is sent to the switching circuit from the detection circuit, and
the circuit board, the battery and the light source being received in a space between the casing and the shade, the circuit board, the battery and the light source being electrically connected with each other by wires.

2. The light source as claimed in claim 1, wherein the base is adapted to be connected to a conventional socket.

3. The light source as claimed in claim 1, wherein the light source is a light emitting diode.

4. The light source as claimed in claim 1, wherein the light source is composed of a plurality of light emitting diodes.

5. The light source as claimed in claim 1, wherein the shade is in a form of a sphere.

6. The light source as claimed in claim 1, wherein the shade is in a form of a spiral tube.

7. The light source as claimed in claim 1, wherein the shade is in a form of three U-shaped tubes.

8. The light source as claimed in claim 1, wherein the base is force-fitted to the casing.

9. The light source as claimed in claim 1, wherein the base is welded to the casing.

10. The light source as claimed in claim 1, wherein the base and the casing are glued together.

11. The light source as claimed in claim 1, wherein the casing is threadedly connected to the shade.

12. The light source as claimed in claim 1, wherein the casing is connected to the shade by a doweled joint.

13. The light source as claimed in claim 1, wherein the casing is connected to the shade by rotating a doweled joint.

14. A non-interruption light source comprising:
a base;
a casing having an end connected to the base;
a battery which is a non-rechargeable battery;
a light source;
a shade having an opening and the other end of the casing being engaged with the opening;
a circuit board comprising a power circuit, a battery circuit, a detection circuit and a switching circuit, an alternative current source providing alternative current to the power circuit and the alternative current being switched into direct current which is supplied to the switching circuit and the detection circuit, the alternative current source providing alternative current to the detection circuit which detects whether or not the alternative current is cut, the battery circuit providing a power supply to the switching circuit which is powered normally by the power circuit, the switching circuit supplying direct current provided by the power circuit to the light source when no signal is sent to the switching circuit from the detection circuit, the switching circuit supplying direct current provided by the battery circuit to the light source when a signal is sent to the switching circuit from -the detection circuit, and
the circuit board, the battery and the light source being received in a space between the casing and the shade, the circuit board, the battery and the light source being electrically connected with each other by wires.

15. The light source as claimed in claim 14, wherein the base is adapted to be connected to a conventional socket.

16. The light source as claimed in claim 14, wherein the light source is a light emitting diode.

17. The light source as claimed in claim 14, wherein the light source is composed of a plurality of light emitting diodes.

18. The light source as claimed in claim 14, wherein the shade is in a form of a sphere.

19. The light source as claimed in claim 14, wherein the shade is in a form of a spiral tube.

20. The light source as claimed in claim 14, wherein the shade is in a form of three U-shaped tubes.

21. The light source as claimed in claim 14, wherein the base is force-fitted to the casing.

22. The light source as claimed in claim 14, wherein the base is welded to the casing.

23. The light source as claimed in claim 14, wherein the base and the casing are glued together.

24. The light source as claimed in claim 14, wherein the casing is threadedly connected to the shade.

25. The light source as claimed in claim 14, wherein the casing is connected to the shade by a doweled joint.

26. The light source as claimed in claim 14, wherein the casing is connected to the shade by rotating a doweled joint.
